(19) United States
(12) Patent Application Publication
(10) Pub. No.: US 2012/0285070 A1
(43) Pub. Date: Nov. 15, 2012

(54) Demagnetically activated ice fishing indicator apparatus

(76) Inventors: Rodney A. Beayon, Poultney, VT (US); Dana M. Carrara, Castleton, VT (US)

(21) Appl. No.: 13/068,314

(22) Filed: May 9, 2011

(51) Int. Cl. A01K 97/01

(52) U.S. Cl. 43/16

(57) ABSTRACT

A demagnetically activated ice fishing indicator apparatus consisting of a magnet affixed to an elongated spindle found within elongated housing above and below which housing are bushings affixable thereto for receipt of the spindle threadably affixed to a spindle top component atop one bushing and to a spool with fishing line just below the other bushing, and; a cover unit with a center hole for receipt of the housing when the cover unit is resting on ice above an ice hole, and; equipped with a semi-metallic flag unit attached to a spring attached via a springclip to an upper portion of the housing such that when a fish bites bait at the end of the fishing line causing the spool, spindle and attached magnet to rotate; the flag unit previously adherent to the housing in view of alignment with the magnet, springs upwardly as the magnet is rotated out of alignment therewith.

### CROSS REFERENCES TO PRIOR OR PARENT APPLICATIONS

There are no prior or parent applications to which the instant invention relates.

### FEDERALLY SPONSORED RESEARCH AND DEVELOPMENT

There is no federally sponsored research and development to which the instant invention relates.

### BACKGROUND OF THE INVENTION

1. Field of the Invention

The invention relates to those sorts of devices serving to notify an ice fisherman when a fish below ice has taken bait at the end of fishing line.

2. Related Art

The art set forth within the Information Disclosure Statement submitted herewith relates to but does not anticipate the instant invention.

### SUMMARY OF THE INVENTION

### A Brief Description of the Invention

The invention is a demagnetically activated ice fishing indicator apparatus. It consists of a magnet affixed to an elongated spindle unit. The spindle is found within an elongated housing unit above and below which there are bushing components each featuring center through holes for receipt of the spindle. The spindle is threadably affixed to a spindle top component positioned above a top one of the two bushing components and it is threadably affixed as well to a spool unit positioned just beneath a bottom one of the two bushing components. There is a semi-metallic flag unit attached to a flag stick in turn affixed to a spring unit that is affixed to a spring clip component affixable to the housing unit. The flag unit is held fast against the housing unit by the force of the magnet. When a fish under water grabs bait at the end of a fishing line wrapped about the spool unit, the spool unit also rotates. This rotation causes the spindle with magnet attached to then also rotate. The rotation of the magnet away from the position it was formerly in while holding the spring loaded flag unit fast to the housing unit causes the flag unit to spring upwardly thus signaling that a fish has been caught. The housing unit is fitted with an outer o-ring being a cover unit ring component. The ring is receivable by a centerhole located in a circumferentially shaped cover unit which serves to stabilize the housing unit, bottom bushing unit and spool unit, respectively located partially within and above and partially below an ice hole while circumscribed by the cover unit resting on the surface of ice about the ice hole.

### Objects of the Invention

Persons while ice fishing have long had to grapple with ice fishing devices that are unstable about ice fishing holes such that such devices will often topple over on windy or blizzardly days. This is a matter of no small amount of consternation not to mention, manifest inconvenience for such persons while ice fishing. The cover unit feature of the instant invention serves to wholly obviate such instability and the frustration naturally associated therewith.

Such persons have moreover, far too often, found themselves beset with notable indicator inefficiency in terms of ascertaining the fact of whether a fish might have been caught or not below the ice. The demagnetic activation feature of the invention serves to obviate such inefficiency by virtue of the notably effective and truly simple manner in which it operates.

Also, such persons are often likewise inconvenienced while transporting such devices because of their size, shape and weight. The invention, on the other hand serves to readily overcome the problem of such inconvenience. In such regards, the invention is very easy to assemble or dissemble and thus clean partswise from time to time. It is likewise notably lightweight and accordingly very easy to carry about. Also, because of the manner in which it is shaped, it is clearly not the least bit bulky.

In summary, the invention is, in view of the foregoing, at the very least, indeed truly new, useful and unique within the scope of the art as respects ice fishing devices.

### DESCRIPTION OF THE DRAWINGS

FIG. 1 shows the intact invention resting on ice with bait in water below the ice being approached by a fish.

FIG. 2 shows what is seen in FIG. 1 but for a fish having taken the bait.

FIG. 3 is a plan view of the intact invention in a demagnetized state.

FIG. 4 is an exploded view of the various parts of the lower portion of the invention.

FIG. 5 is an exploded view of the whole invention.

FIG. 6 is a top perspective view of a first cover unit.

FIG. 7 is a bottom plan view of the cover unit shown in FIG. 6.

FIG. 8 is a perspective view of a second cover unit.

FIG. 9 is a bottom plan view of the cover unit shown in FIG. 8.

FIG. 10 is a perspective view of a third cover unit.

FIG. 11 is a bottom plan view of the cover unit shown in FIG. 10.

FIG. 12 is a bottom perspective view of the cover unit of FIG. 10 serving to highlight centralized ridging.

FIG. 13 is an isolated front plan view of a medial portion of the invention.

FIG. 14 differs from FIG. 13 in respect of the flag variant therein shown.

FIG. 15 is an isolated view of a first flag variant in apposition to a flag stick.

FIG. 16 shows the first flag variant conjoined with the flag stick.

FIG. 17 is an isolated view of a second flag variant in apposition to a flag stick.

FIG. 18 differs from FIG. 16 only in that the second flag variant is shown turned through an angle in excess of 90°.

FIG. 19 is an isolated exploded view of the spindle unit shown in apposition to the spindle top component of the invention.

FIG. 20 is an isolated perspective view of an upper portion of the invention.

FIG. 21 is an isolated perspective view of the top bushing component of the invention.

FIG. 22 is an isolated perspective view of the bottom bushing component of the invention.

FIG. 23 is an isolated perspective view of the spool unit of the invention.

FIG. 24 shows the flag-springclip complex of the invention in “transport” mode.

### A BRIEF DESCRIPTION OF THE PREFERRED EMBODIMENTS

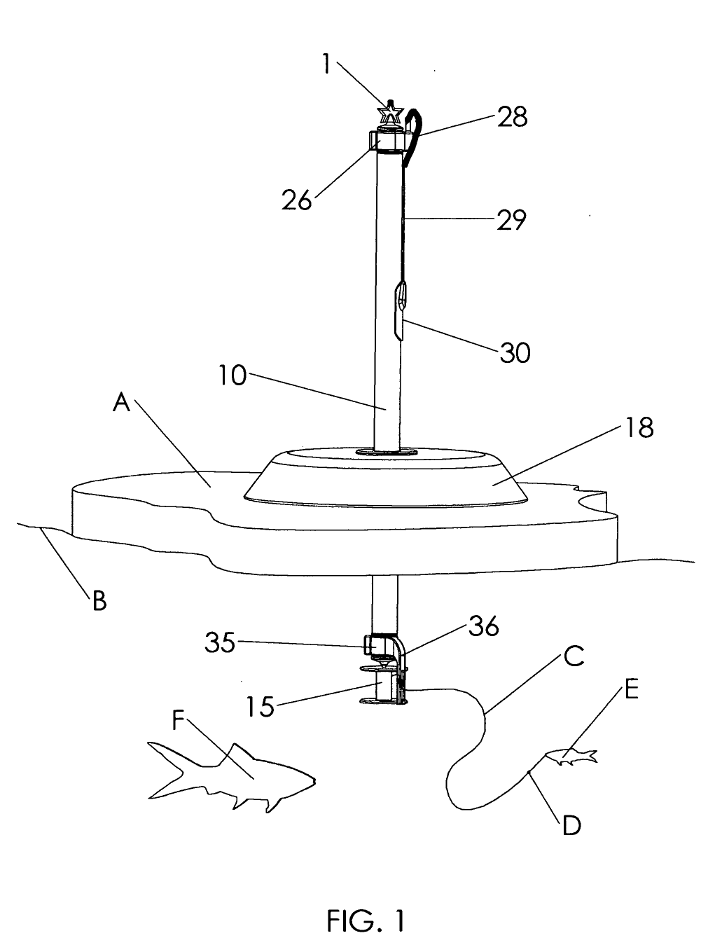

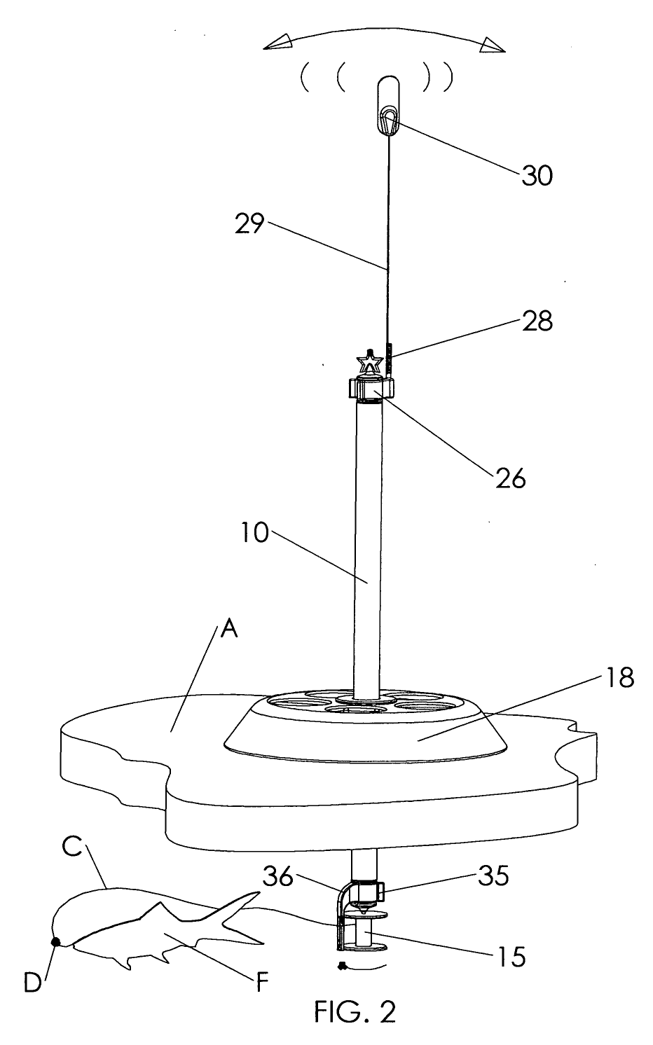

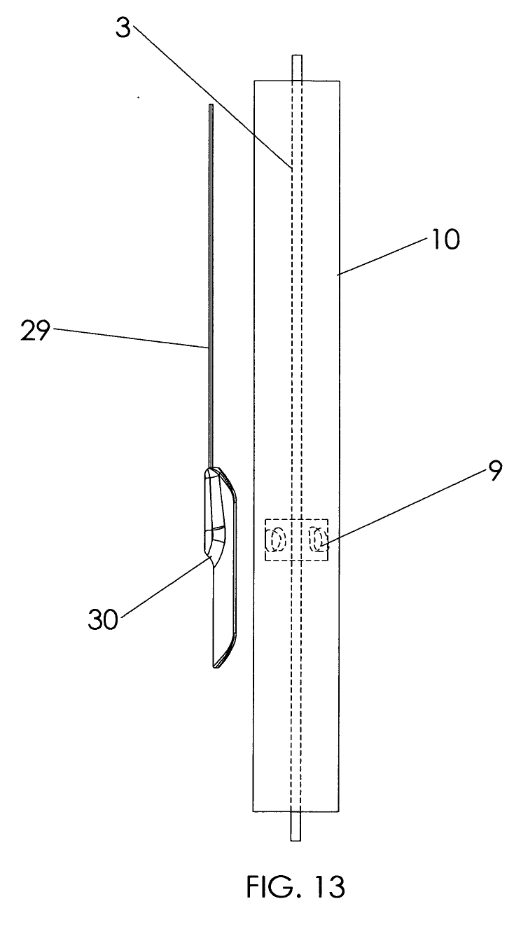

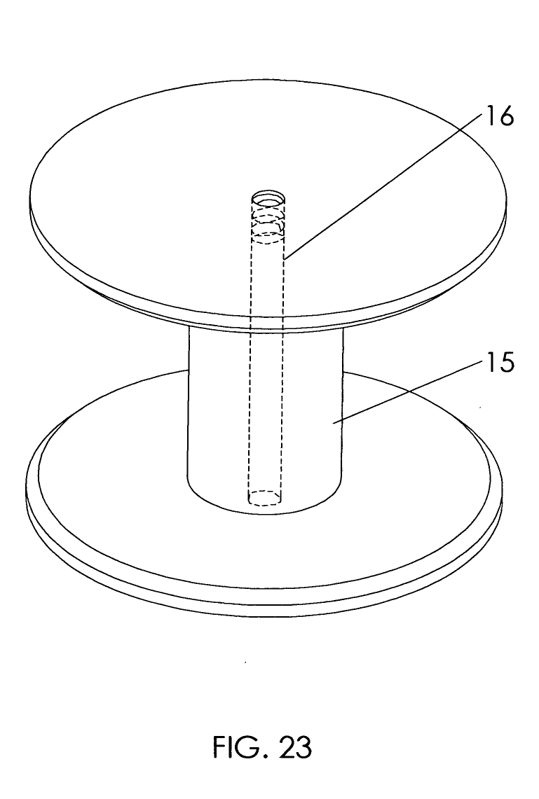

FIG. 1 shows the intact invention resting on ice A with bait E in water B below the surface of ice A and being approached by a fish F. Bait E with sinker D is attached to fishing line C windable about spool unit 15 of the invention. FIG. 2 shows what is seen in FIG. 1 but in FIG. 2, fish F has taken bait E. These two (2) figures FIG. 1 and FIG. 2 illustrative the operative essence of the invention. A first flag unit 30 held by a curvaceously ending first flagstick 29 as shown in FIG. 1, is held magnetically to the outer walling of hollow housing unit 10 by magnet 9 affixed to spindle unit 3 within the interior of housing unit 10 as is more clearly depicted in FIG. 13. But when fish F takes bait E as shown in FIG. 2, this causes spool unit 15 to rotate. Spool unit 15 is threadably held to spindle unit 3 via bottom end 17 of spindle unit 3 with threading being threadably inserted into a second vertically inclined hole 16 with threading as can be noted with reference to FIG. 23; though for a second embodiment, spool unit 15 could also be pressfittably held to spindle unit 3 without any threading at the bottom end 17 of spindle unit 3 so pressfitted within an unthreaded hole 16. Rotation of spool unit 15 causes rotation of spindle unit 3 which in turn rotates magnet 9 away from a preset locus aligned with the locus of first flag unit 30 initially magnetically held up against outer walling of housing unit 10.

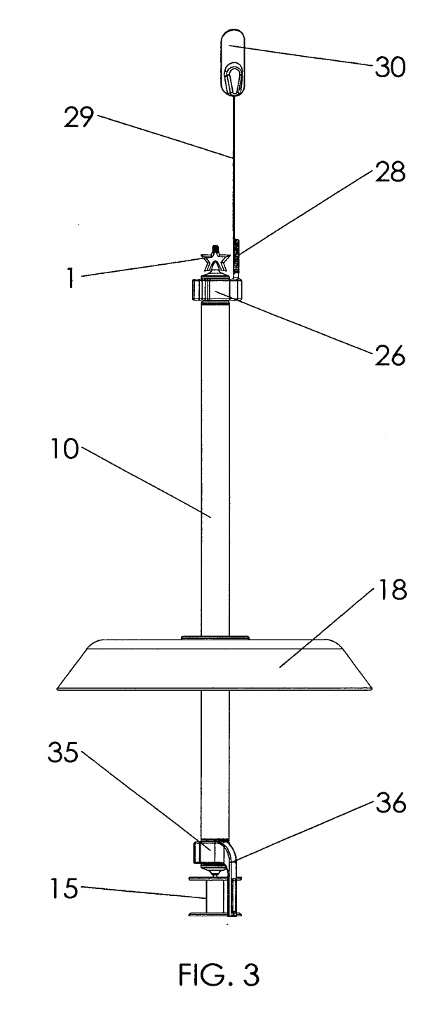

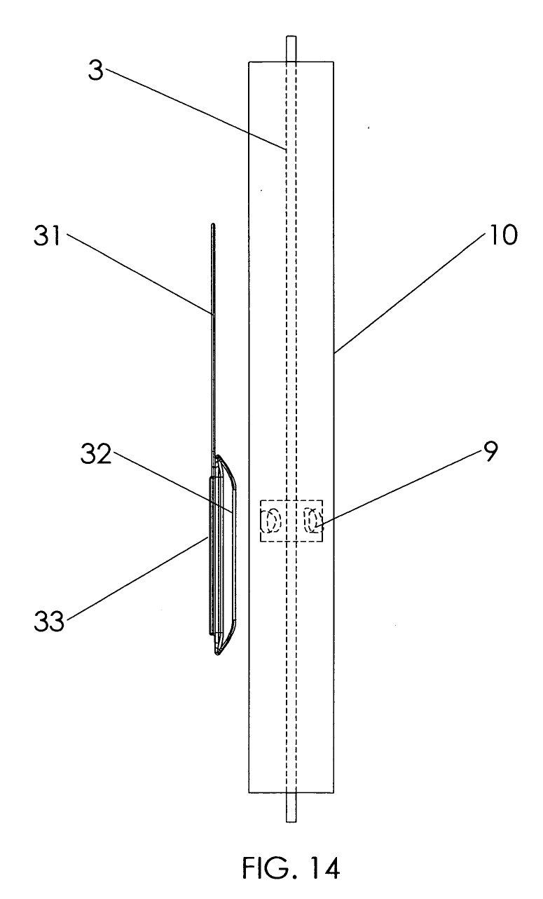

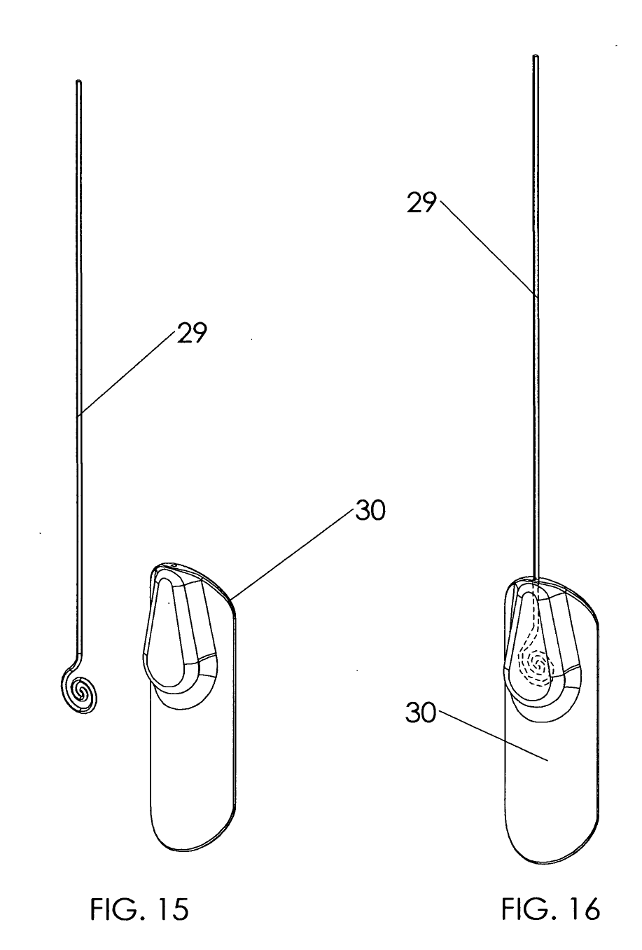

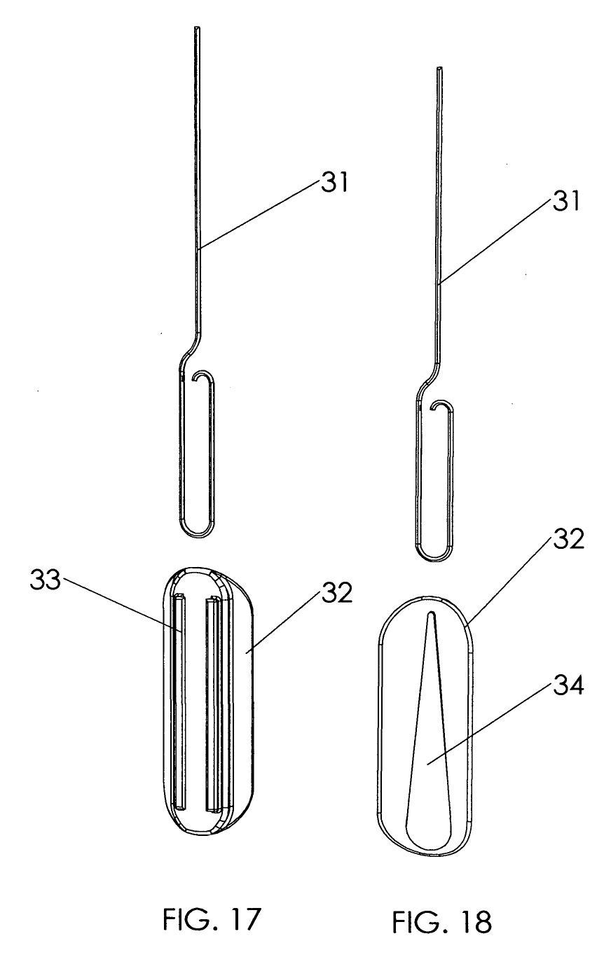

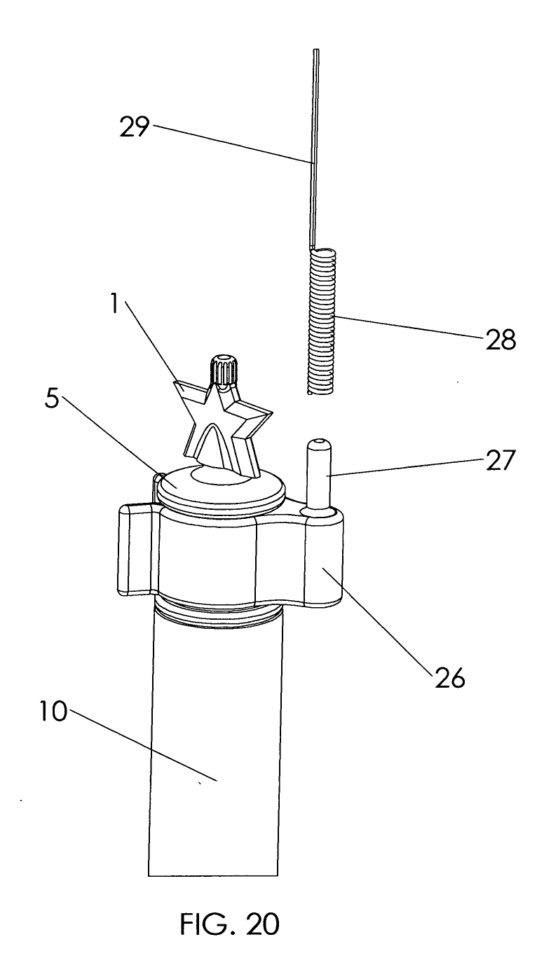

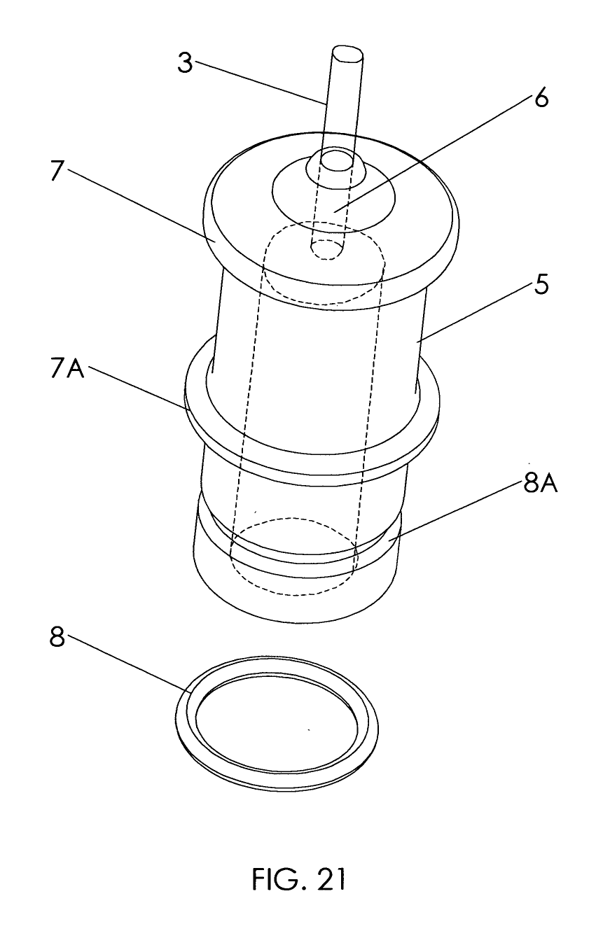

Magnetization in such preset state is so accomplished whereas the curvaceous end portion of flag stick 29 is metallic and is embedded within flag unit 30 as can be noted with reference to FIGS. 15 and 16. When spool unit 15 undergoes rotation, as fishing line C unwinds when fish F takes bait E, spindle unit 3 also rotates affixed magnet 9 away from the above-mentioned preset alignment with flag unit 30 thereby causing flag unit 30 once demagnetized to fly upwardly perforce of the action of spring unit 28 affixed to flagstick 29 thus alerting an ice fishing person of a bite as can be noted with reference to FIG. 2. Yet, another variant in respect of conjunction of a flagstick with a flag unit can be noted with reference to FIGS. 14, 17 and 18. These drawing figures show a second flag unit 32 equipped posteriorly with sleeving 33 affixed externally thereto. Sleeving 33 holds curvaceously ending, metallic second flagstick 31 in such a manner as to allow flagstick 31 to be firmly held at various points, up to down, against the posterior portion of second flag unit 32 that contains embedded within it, droplet shaped metallic piece 34 as shown in FIG. 18. The facility for firmly holding flagstick 31 at various levels within sleeving 33 allows for variable strength of magnetic attractivity as between flag unit 32 and magnet 9. This feature is important wherever there may be any notable measure of any invariate ambient rotation of spool unit 15 during a period of strong water currents involving water B below where the invention might be placed over a hole in ice A over water B. By pushing flagstick 31 lower down into sleeving 33, being the same as moving flag unit 32 upwardly on flagstick 31 within sleeving 33, one can cause the bottom portion of metallic piece 34, a larger and hence more metallic portion thereof, to lie in alignment with magnet 9 so as to make for a greatest magnetic attractivity as a means of retarding somewhat, any such ambient rotation of spool unit 15 to thereby militate as against any inadvertent demagnetization of a flag unit 32 caused i.e. by relatively strong currents rather than by an actual fish bite. FIG. 3 is a plan view of the invention in a demagnetized state. First flag unit 30 affixed to first flag stick 29 is demagnetically sprung upwardly as magnet 9 is rotated away from first flag unit 30 previously held by magnet 9 as against the outer walling of housing unit 10. Such springing upwardly is accomplished by way of the action of spring unit 28 affixed to vertically inclined stem 27 being apart of first springclip component 26 such as is more clearly depicted in FIG. 20. The whole of the foregoing occurs with demagnetization as fish F takes bait E and pulls on line C thereby causing spool unit 15 and spindle unit 3 concomitantly to rotate and accordingly cause magnet 9 to rotate away from the preset position whereat it would have previously been aligned with a flag unit 29 or a flag unit 32 being accordingly, previously held fast to the outer walling of housing unit 10.

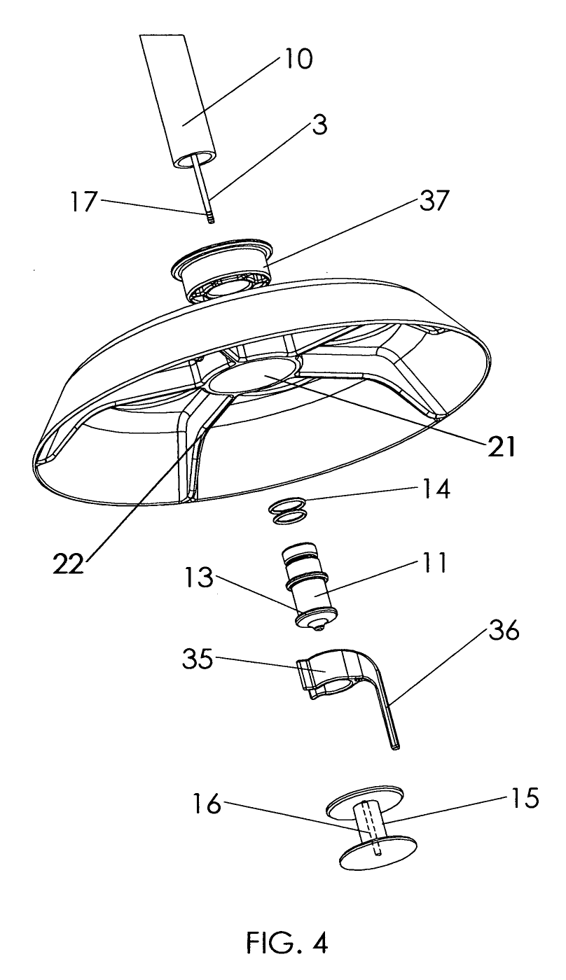

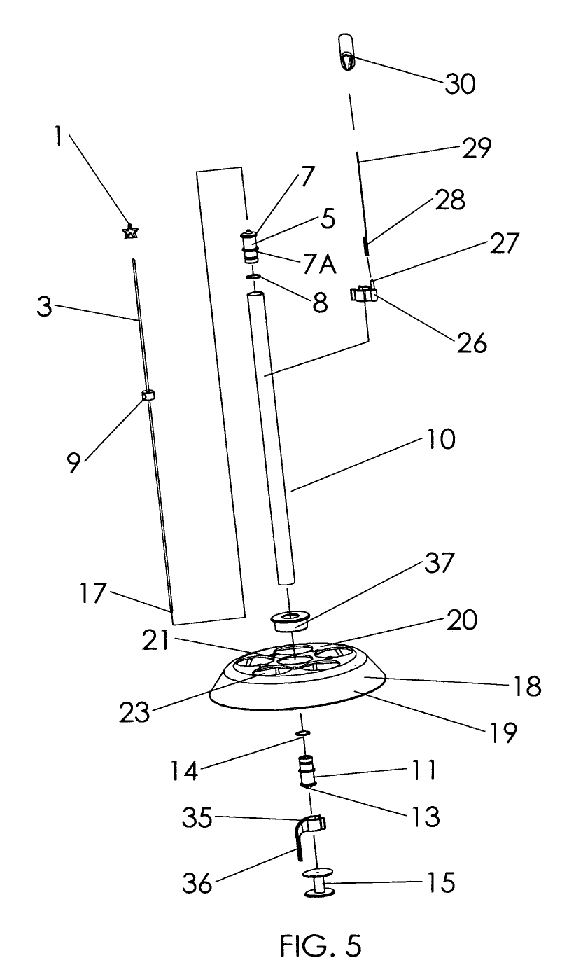

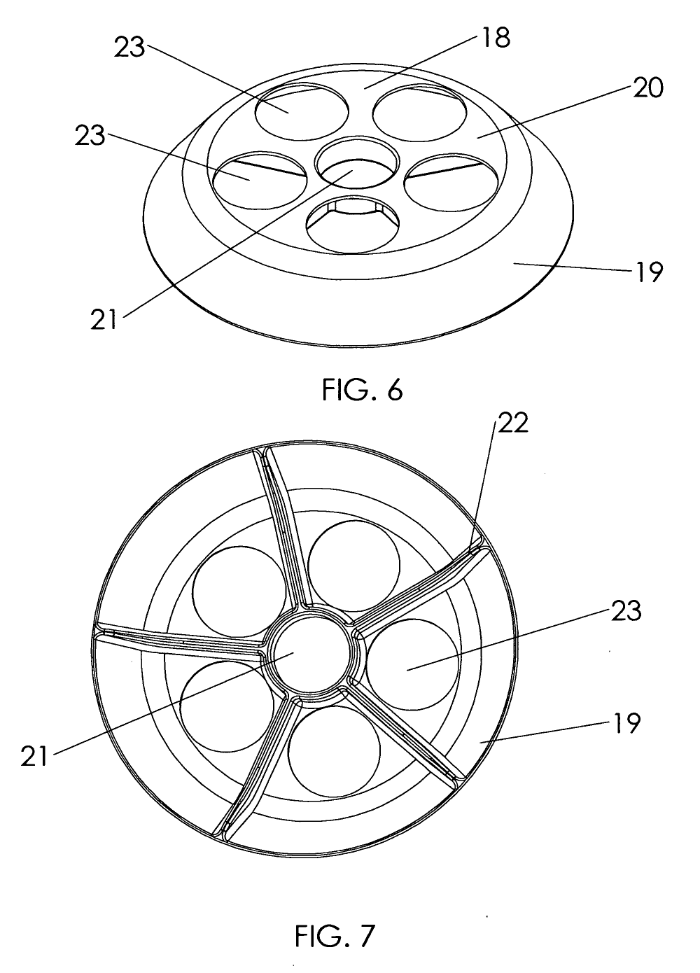

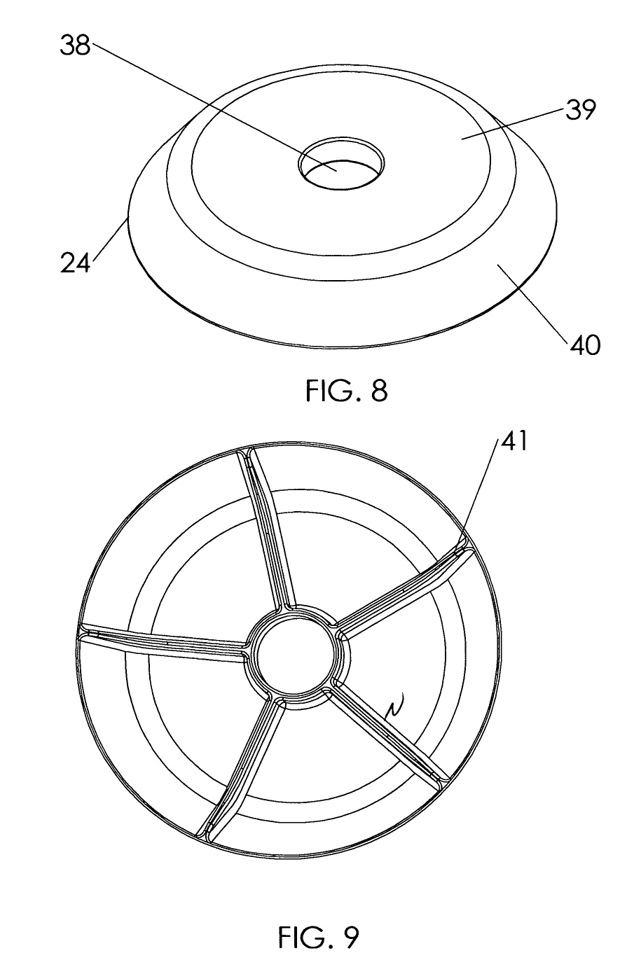

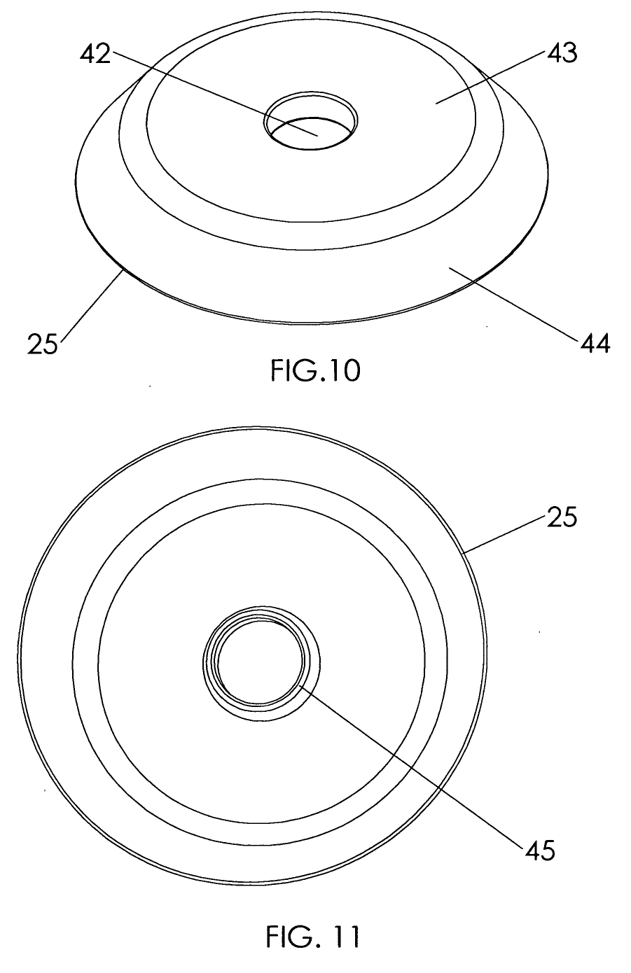

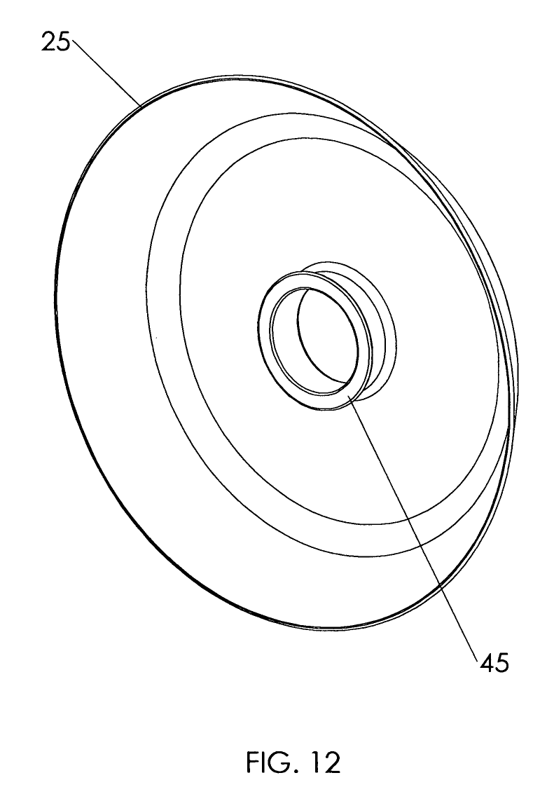

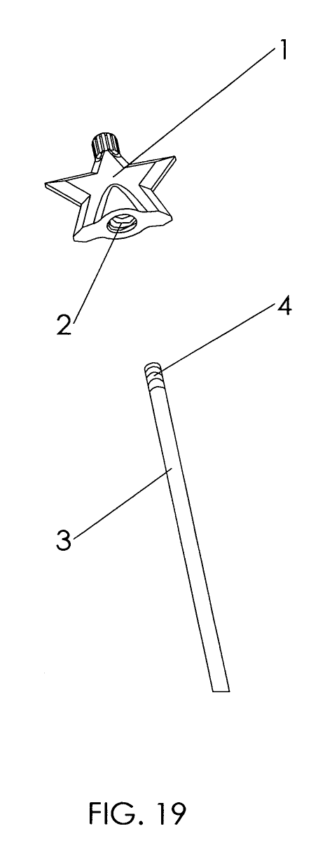

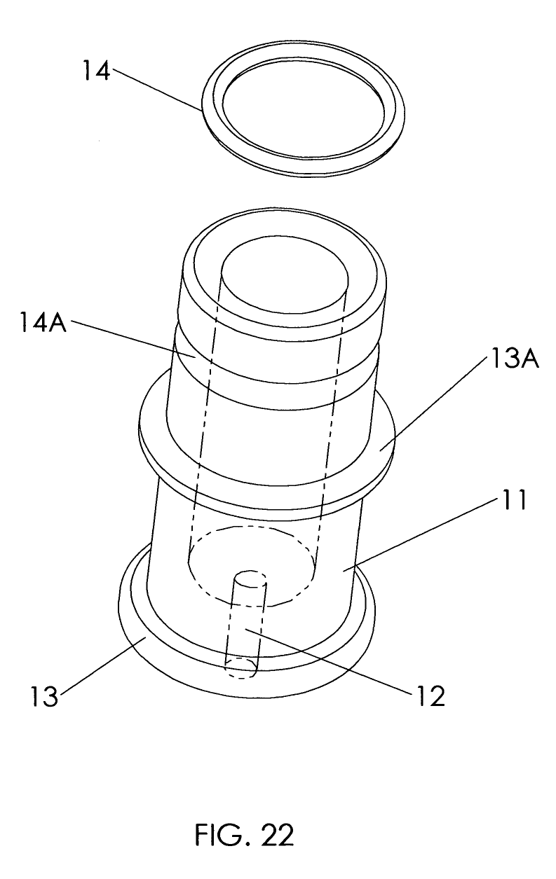

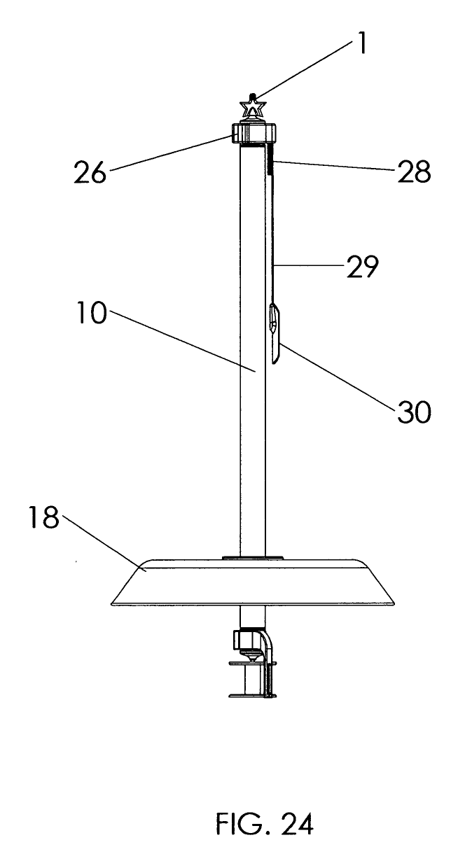

FIG. 4 is an exploded view of the various parts of the lower part of the invention. FIG. 4 serves to illustrate the manner in which spindle unit 3 is held within housing unit 10. Also seen is the lower end portion 17 of spindle unit 3 shown with threading and ultimately foreordained to be threaded into second vertically inclined hole 16 with threading within spool unit 15. Also seen is cover unit ring component 37 which fits into centerhole 21 of first cover unit 18 and about the outer walling of housing unit 10 in order snugly hold housing unit 10 about and ultimately through centerhole 21. Bottom bushing component o-ring 14 fitted about bottom o-ring groove 14A cut into bottom bushing 11 as shown with particularity in FIG. 22 serves to hold bottom bushing component 11 within a lower portion of housing unit 10 so as to also militate against moisture or solutes or contaminants from water B creeping upwardly into the interior of housing unit 10. Bottom bushing component 11 is held within housing unit 10 down to a level of lower ledging 13 of bottom bushing component 11. FIG. 22, is an isolated perspective view of bottom bushing component 11 showing O-ring 14 about bushing component 11 and second vertically inclined through hole 12 therein. Spindle unit 3 passes through hole 12 as it is then affixed via threaded lower portion 17 to spool unit 15 by way of being threaded into threaded hole 16. Clipped to a lower portion of bushing component 11 is a second spring clip component 35 to which there is affixed as also shown in FIG. 4 a line guide unit 36 with a through hole therein located. Spring clip component 35 is held to bushing component 11 between lower ledging 13 and medial bottom bushing ledging 13A depicted in FIG. 22 so as to thereby prevent spring clip component 35, once so affixed to bottom bushing component 11, from possibly creeping upwardly or downwardly about bushing component 11. The foregoing features of the invention are moreover shown in FIG. 5. FIGS. 6 and 7 depict first cover unit 18 of the invention characterized by the presence of a centerhole 21 for receipt of cover unit ring component 37 as well as having a topside 20 and outwardly flaring lateral walling 19 together with transparent windows 23 in topside 20 and reinforced with optional support ridging 22 as seen in a bottom plan view of cover unit 18 with reference to FIG. 7. FIGS. 8 and 9 depict a second variant of a cover unit being a cover unit 23 with a centerhole 38, topside 39 and lateral walling 40 as well as optional support ridging 41 as seen in a bottom view of cover unit 18 with reference to FIG. 9. A third variant of a cover unit being cover unit 25 as shown in FIGS. 10 and 11 features a centerhole 42, topside 43, lateral walling 44 and optional centerhole support ridging 45 as seen in a bottom plan view of cover unit 25 with reference to FIG. 11. FIG. 12 is a perspective view of the third variant serving to depict, in greater detail, ridging 45. Windows 23 of cover unit 18 enable an ice fishing person to see into water B below a hole in ice surface A so as to perhaps gain an enhanced understanding of whatever may be transpiring below the hole in ice surface A. It will be seen with reference to FIGS. 6, 7, 8, 9, 10 and 11 that topsides 20, 39 and 43 of cover units 18, 23 and 25 respectively have a breadth between any two opposing points thereon that is always less than a breadth between any two opposing points on bottom edging of lateral walling 19, 40 and 44 of cover units 18, 23 and 25 respectively. First vertically inclined threaded hole 2 in spindle top component 1 serves to receive threaded top end 4 of spindle unit 3, and; spindle unit 3 is insertable through first vertically inclined hole 6 in top bushing component 5, all as can be seen with reference to FIGS. 19 and 21. Upper ledging 7 circumscribing top bushing component 5 and top bushing O-ring 8 are also seen in FIG. 21. First o-ring 8 fitted about top o-ring groove 8A cut into top bushing 5 as shown with particularlity in FIG. 21 serves to dependably hold top bushing component 5 within housing unit 10, and; medial top bushing ledging 7A shown with particularity in FIG. 21 serves to retard top bushing component 5 from falling into the lumen of housing unit 10. Upper ledging 7 also seen in FIG. 21 together with medial top bushing ledging 7A serve to prevent spring clip component 26 affixed therebetween to top bushing component 5 as shown in FIG. 20 from riding upwardly or downwardly about bushing component 5. Also, a second embodiment could feature a non-threaded top end 4 of spindle unit 3 being pressfitted into a non-threaded hole 2 in spindle top component 1. Spindle top component 1 is rotated with spindle unit 3 as spool unit 15 rotates when fishing line C passing through the through hole in line guide unit 36 is pulled by a fish F having taken bait E to thus also alert an ice fishing person to the fact of a fish F having taken the bait E. FIG. 24 serves to illustrate how by simply turning first snapclip 26 upside down and then reaffixing it to top bushing component 5, the invention can be carried about still intact without concern for interaction as between a magnet 9 and either a flag unit 30 or for that matter, a flag unit 32. Turning snapclip 26 upside down and then reattaching it to top bushing component 5 serves to operably deactivate spring unit 28.

Cover units 18 or 24 or 25 via cover unit ring component 37 within centerhole 21 or 38 or 42 as the case may be with there also being inserted through component 37, the body of housing unit 10; serve to hold the intact invention dependably over a hole in ice surface A over water B with the lower portion thereof being dependably held within water B below ice surface A. Fish F taking bait E affixed to fishing line C; also equipped with a sinker D, wound through line guide unit 36 affixed to snapclip component 35 in turn affixed to bottom bushing component 11, with fishing line C wound about spool unit 15; causes spool unit 15 to rotate. This, in turn causes spindle unit 3 affixed to spool unit 15 as described above to likewise rotate. The rotation of spindle unit 3 causes magnet 9 to become non-aligned with either flag unit 30 or flag unit 32 such that whichever flag unit is in use is then thrown upwardly by the then unimpeded force of spring unit 28 acting on either flagstick 29 or flagstick 31, as the case may be, thereby serving to thereby alert an ice fishing person as to the fact of the bite having just taken place. Spindletop component 1 also affixed to spindle unit 3 also rotates as well thereby serving as an additional indicator of the fact of a bite.

Respectfully submitted, the instant invention is not merely new, useful and unique, but rather it is indeed arguably quite revolutionary in the art of devices serving to facilitate catching fish in water below ice.

What is claimed is:

1. A demagnetically activated ice fishing indicator apparatus, comprising:
a. a spindle top component;
b. a first vertically inclined threaded closed hole located in said spindle top component;
c. a spindle unit;
d. a threaded top end of said spindle unit;
e. a top bushing component;
f. a first vertically inclined through hole located in said top bushing component;
g. upper ledging circumscribing an uppermost portion of said top bushing component;
h. medial top bushing ledging circumscribing said top bushing component at a level below said uppermost portion thereof;
i. a top o-ring groove cut into and about said top bushing component at a level below said level whereat said medial top bushing ledging is located;
j. a first o-ring circumscribing said top bushing component and fitted into said top o-ring groove;
k. a magnet about a portion of said spindle unit and affixed thereto;
l. a hollow, elongated housing unit;
m. a bottom bushing component;
n. a second vertically inclined through hole located in said bottom bushing component;
o. lower ledging circumscribing a lowermost portion of said bottom bushing component;
p. medial bottom bushing ledging circumscribing said bottom bushing component at a level above said lowermost portion thereof;
q. a bottom o-ring groove cut into and about said bottom bushing component at a level above said level whereat said medial bottom bushing ledging is located;
r. a second bushing o-ring circumscribing said bottom bushing component and fitted into said bottom o-ring groove;
s. a spool unit for receipt of elongated fishing line material windable about it;
t. a second vertically inclined threaded closed hole located in said spool unit;
u. a threaded bottom end of said spindle unit;
v. said spindle unit being threadably affixed at said top end thereof to said spindle top component within said first threaded closed hole and being receivable through said first through hole prior to said affixation thereto of said magnet and thereafter receivable along with said top bushing component by said housing unit at an upper end of said housing unit, and said spindle unit being, in turn, likewise receivable through said second through hole with said bottom bushing component being concomitantly receivable by said housing unit at a lower end thereof and then said spindle unit being threadably affixed at said bottom end thereof to said spool unit within said second threaded closed hole;
w. a cover unit with circumferentially shaped lateral walling connected to a topside thereof;
x. a cover unit centerhole located in said topside;
y. said topside having a breadth as between any two opposing points thereon less than a breadth as between any two opposing points on bottom edging of said lateral walling.
z. a cover unit ring component frictionally affixed about outer walling of said housing unit;
aa. said cover unit ring component being receivable within said cover unit centerhole;
bb. said topside of said cover unit being characterized by a presence thereon of a plurality of translucent windows;
cc. multiple pieces of supportive ridging being interiorly affixed to said lateral walling of said cover unit and with each of said pieces extending from said bottom edging thereof to said centerhole thereof;
dd. a first springclip component with a vertically inclined stem component affixed to a top side thereof;
ee. a spring unit being affixed at a first end thereof to a free end of said stem component;
ff. a metallic flag stick being affixed at a first end thereof to a second end portion of said spring unit;
gg. a flag unit being affixable to and about a curvaceous second end of said flag stick;
hh. said first springclip component being affixable to and about said top bushing component;
ii. a line guide unit with a hole within it for receipt of said fishing line material;
jj. said line guide unit being affixed to a second springclip component, and;
kk. said second springclip component being affixable to and about said bottom bushing component.

2. A demagnetically activated ice fishing indicator apparatus, comprising:
a. a spindle top component;
b. a first vertically inclined threaded closed hole located in said spindle top component;
c. a spindle unit;
d. a threaded top end of said spindle unit;
e. a top bushing component;
f. a first vertically inclined through hole located in said top bushing component;
g. upper ledging circumscribing an uppermost portion of said top bushing component;
h. medial top bushing ledging circumscribing said top bushing component at a level below said uppermost portion thereof;
i. a top o-ring groove cut into and about said top bushing component at a level below said level whereat said medial top bushing ledging is located;
j. a first bushing o-ring circumscribing said top bushing component below said upper ledging;
k. a magnet about a portion of said spindle unit and affixed thereto;
l. a hollow, elongated housing unit;
m. a bottom bushing component;
n. a second vertically inclined through hole located in said bottom bushing component;
o. lower ledging circumscribing a lowermost portion of said bottom bushing component;
p. medial bottom bushing ledging circumscribing said bottom bushing component at a level above said lowermost portion thereof;
q. a bottom o-ring groove cut into and about said bottom bushing component at a level above said level whereat said medial bottom bushing ledging is located;
r. a second bushing o-ring circumscribing said bottom bushing component above said lower ledging;
s. a spool unit for receipt of elongated fishing line material windable about it;
t. a second vertically inclined threaded closed hole located in said spool unit;
u. a threaded bottom end of said spindle unit;
v. said spindle unit being threadably affixed at said top end thereof to said spindle top component within said first threaded closed hole and being receivable through said first through hole prior to said affixation thereto of said magnet and thereafter receivable along with said top bushing component by said housing unit at an upper end of said housing unit, and said spindle unit being, in turn, likewise receivable through said second through hole with said bottom bushing component being concomitantly receivable by said housing unit at a lower end thereof and then said spindle unit being threadably affixed at said bottom end thereof to said spool unit within said second threaded closed hole;
w. a cover unit with circumferentially shaped lateral walling connected to a topside thereof;
x. a cover unit centerhole located in said topside;
y. said topside having a breadth as between any two opposing points thereon less than a breadth as between any two opposing points on bottom edging of said lateral walling.
z. a cover unit ring component frictionally affixed about outer walling of said housing unit;
aa. said cover unit ring component being receivable within said cover unit centerhole;
bb. a first springclip component with a vertically inclined stem component affixed to a top side thereof;
cc. a spring unit being affixed at a first end thereof to a free end of said stem component;
dd. a metallic flag stick being affixed at a first end thereof to a second end portion of said spring unit;
ee. a flag unit being affixable to and about a curvaceous second end of said flag stick;
ff. said first springclip component being affixable to and about said top bushing component;
gg. a line guide unit with a hole within it for receipt of said fishing line material;
hh. said line guide unit being affixed to a second springclip component, and;
ii. said second springclip component being affixable to and about said bottom bushing component.

3. A demagnetically activated ice fishing indicator apparatus, comprising:
a. a spindle top component;
b. a first vertically inclined closed hole located in said spindle top component;
c. a spindle unit;
d. a top bushing component;
e. a first vertically inclined through hole located in said top bushing component;
f. upper ledging circumscribing an uppermost portion of said top bushing component;
g. medial top bushing ledging circumscribing said top bushing component at a level below said uppermost portion thereof;
h. a magnet about a portion of said spindle unit and affixed thereto;
i. a hollow, elongated housing unit;
j. a bottom bushing component;
k. a second vertically inclined through hole located in said bottom bushing component;
l. lower ledging circumscribing a lowermost portion of said bottom bushing component;
m. medial bottom bushing ledging circumscribing said bottom bushing component at a level above said lowermost portion thereof;
n. a spool unit for receipt of elongated fishing line material windable about it;
o. a second vertically inclined closed hole located in said spool unit;
p. said spindle unit being pressfitted at a top end thereof into said first vertically inclined closed hole and being receivable through said first through hole prior to said affixation thereto of said magnet and thereafter receivable along with said top bushing component by said housing unit as said top bushing component is pressfitted into an upper end of said housing unit, and said spindle unit being in turn, likewise receivable through said second through hole with said bottom bushing component being pressfitted into a lower end of said housing unit and with said spindle unit being pressfittably receivable within said second vertically inclined closed hole;
q. a cover unit with circumferentially shaped lateral walling connected to a topside thereof;
r. a cover unit centerhole located in said topside;
s. said topside having a breadth as between any two opposing points thereon less than a breadth as between any two opposing points on bottom edging of said lateral walling;
t. a cover unit ring component frictionally affixed about outer walling of said housing unit;
u. said cover unit ring component being receivable within said cover unit centerhole;
v. a first springclip component with a vertically inclined stem component affixed to a top side thereof;
w. a spring unit being affixed at a first end thereof to a free end of said stem component;
x. a metallic flag stick being affixed at a first end thereof to a second end portion of said spring unit;
y. a flag unit being affixable to and about a curvaceous second end of said flag stick;
z. said first spring clip component being affixable to and about said top bushing component;
aa. a line guide unit with a hole within it for receipt of fishing line materials;
bb. said line guide unit being affixed to a second springclip component, and;
cc. said second springclip component being affixable to and about said bottom bushing component.

4. The flag unit of claim 2, whereby said flag unit is equipped with sleeving affixed to posterior walling thereof for receipt of said curvaceous second end of said flag stick.

5. The flag unit of claim 4, whereby an amorphously shaped piece of metal, more massive at one end thereof than at a second end thereof, is embedded within said flag unit.

6. The flag unit of claim 3, whereby said flag unit is equipped with sleeving affixed to posterior walling thereof for receipt of said curvaceous second end of said flag stick.

7. The flag unit of claim 6, whereby an amorphously shaped piece of metal, more massive at one end thereof than at a second end thereof, is embedded within said flag unit.

8. The cover unit of claim 2, whereby said topside thereof is characterized by a presence thereon of a plurality of translucent windows.

9. The cover unit of claim 3, whereby said topside thereof is characterized by a presence thereon of a plurality of translucent windows.

10. The cover unit of claim 2, whereby, interiorly affixed to said lateral walling thereof are multiple pieces of supportive ridging, with each of said pieces extending from said bottom edging thereof to said centerhole thereof.

11. The cover unit of claim 3, whereby interiorly affixed to said lateral walling thereof are multiple pieces of supportive ridging, with each of said pieces extending from said bottom edging thereof to said centerhole thereof.

12. The cover unit of claim 2, whereby supportive ridging is interiorly affixed about said centerhole thereof.

13. The cover unit of claim 3, whereby supportive ridging is interiorly affixed about said centerhole thereof.
